(19) United States
(12) Patent Application Publication
(10) Pub. No.: US 2024/0297296 A1
(43) Pub. Date: Sep. 5, 2024

(54) METHOD OF MANUFACTURING ELECTRODE COMPOSITION FOR LITHIUM-ION BATTERIES

(71) Applicant: APB CORPORATION, Chiyoda-ku Tokyo (JP)

(72) Inventors: Hideki ISHITANI, Kyoto-shi Kyoto (JP); Takuya MIYAMURA, Kyoto-shi Kyoto (JP); Shogo ISOMURA, Kyoto-shi Kyoto (JP); Hideaki HORIE, Chiyoda-ku Tokyo (JP)

(21) Appl. No.: 18/571,722

(22) PCT Filed: Jun. 21, 2022
(86) PCT No.: PCT/JP2022/024641

§ 371 Date: Dec. 19, 2023

(30) Foreign Application Priority Data
Jun. 21, 2021 (JP) 2021-102560

(51) Int. Cl. H01M 4/1399; H01M 4/02; H01M 4/36; H01M 4/60; H01M 4/62

(52) U.S. Cl. CPC H01M 4/1399; H01M 4/366; H01M 4/604; H01M 4/625; H01M 2004/028

(57) ABSTRACT

A method of manufacturing an electrode composition for lithium-ion batteries that can prevent other electrode materials from forming aggregates on the surface of the coating layer of coated electrode active material particles, and that has good fluidity, and that can suppress deterioration of battery performance, can be provided.

The method of manufacturing an electrode composition for lithium-ion batteries, the method including: a first mixing step of obtaining a powder for electrodes by mixing coated electrode active material particles for lithium-ion batteries, in which at least a part of the surface of the electrode active material particles is coated with a polymer compound, with a first conductive filler having an aspect ratio of 10 or less; and a second mixing step of obtaining an electrode composition by mixing the powder for electrodes with a second conductive filler having an aspect ratio of 15 or more.

### FIELD OF THE INVENTION

This invention relates to a method of manufacturing an electrode composition for lithium-ion batteries.

### BACKGROUND ART

Lithium-ion batteries have come to be widely used in a variety of usages as secondary batteries that can achieve high energy density and high power density. Therefore, various materials have been studied in order to develop higher performance lithium-ion batteries.

In terms of electrode active material particles, studies have been made to coat the surface of the electrode active material particles with a resin. For example, a method of mitigating changes in the volume of an electrode by coating the surface of an active material with a resin having both a tensile elongation at break of 10% or more in a saturated liquid absorption state and a liquid absorption rate of 10% or more when immersed in electrolyte, is disclosed in Patent Reference 1.

### CITATION LIST

### Patent Literature

[Patent Reference 1] WO2015/005117

With regard to resins that coat electrode active material particles (also referred to as coating resins), while considering various ways to improve battery performance, the usage of a resin with strong tackiness as a coating resin has been considered.

However, if the coating resin has strong tackiness, when mixing the coated electrode active material particles, which are coated with the resin, with other electrode materials such as a conductive assistant, a phenomenon in which other electrode materials form aggregates on the surface of the coating resin (also referred to as the coating layer) might occur. Due to this, there was a problem that manufacturing efficiency (fluidity) and battery performance were deteriorated.

### BRIEF SUMMARY OF THE INVENTION

### Problems that Invention is to Solve

The present invention has been made in view of the above-mentioned problems and has an objective to provide a method of manufacturing an electrode composition for lithium-ion batteries, wherein the method can prevent other electrode materials from forming aggregates on the surface of the coating layer of coated electrode active material particles, has good fluidity, and can suppress deterioration of battery performance.

### Means to Solve the Problems

In order to solve the above problems, the present inventors have discovered that the above problems could be solved by mixing a conductive filler with coated electrode active material particles for lithium-ion batteries in a specific order according to the shape of the conductive filler. This discovery has led to this invention. In other words, this invention is a method of manufacturing an electrode composition lithium-ion for batteries, the method including: a first mixing step of obtaining a powder for electrodes by mixing coated electrode active material particles for lithium-ion batteries, in which at least a part of the surface of the electrode active material particles is coated with a polymer compound, with a first conductive filler having an aspect ratio of 10 or less; and a second mixing step of obtaining an electrode composition by mixing the powder for electrodes with a second conductive filler having an aspect ratio of 15 or more.

### Effects of the Invention

According to this invention, an electrode composition for lithium-ion batteries that can prevent other electrode materials from forming aggregates on the surface of the coating layer of coated electrode active material particles, and that has good fluidity, and that can suppress deterioration of battery performance, can be provided.

### BRIEF DESCRIPTION OF DRAWINGS

FIG. 1 is a SEM photograph of carbon nanofibers (CNF).

FIG. 2 is a SEM photograph of flaky graphite (UP).

FIG. 3 is a scanning electron microscope (SEM) photograph of the cathode composition prepared in Example 1.

FIG. 4 is a scanning electron microscope (SEM) photograph of the anode composition prepared in Example 5.

FIG. 5 is a scanning electron microscope (SEM) photograph of the cathode composition prepared in Comparison 1.

FIG. 6 is a scanning electron microscope (SEM) photograph of the anode composition prepared in Comparison 4.

### DESCRIPTION OF EMBODIMENTS

A method of manufacturing an electrode composition for lithium-ion batteries according to this invention, the method including: a first mixing step of obtaining a powder for electrodes by mixing coated electrode active material particles for lithium-ion batteries, in which at least a part of the surface of the electrode active material particles is coated with a polymer compound, with a first conductive filler having an aspect ratio of 10 or less; and a second mixing step of obtaining an electrode composition by mixing the powder for electrodes with a second conductive filler having an aspect ratio of 15 or more.

The method of manufacturing an electrode composition for lithium-ion batteries, according to this invention, can reduce the tackiness of the surface of the coating layer by covering the surface of the coating layer of the coated electrode active material particles using the first conductive filler having a small aspect ratio. Therefore, even if the second conductive filler with a large aspect ratio is added, it is possible to suppress the conductive filler from forming aggregates on the surface of the coating layer. Therefore, the method can provide an electrode composition for lithium-ion batteries with good fluidity and can suppress deterioration of battery performance.

First, the first mixing step will be explained.

### <First Mixing Step>

The first mixing step is a step of obtaining a powder for electrodes by mixing coated electrode active material particles for lithium-ion batteries, in which at least a part of the surface of the electrode active material particles is coated with a polymer compound, with a first conductive filler having an aspect ratio of 10 or less.

### (Coated Electrode Active Material Particles for Lithium-Ion Batteries)

The coated electrode active material particles for lithium-ion batteries are the particles where at least a part of the surface of the electrode active material particles is coated with a polymer compound. Herein, a layer composed of a polymer compound that coats the surface of electrode active material particles is also referred to as a coating layer.

The electrode active material particles may be cathode active material particles or anode active material particles. The electrode composition for lithium-ion batteries obtained by the method of manufacturing an electrode composition for lithium-ion batteries of the present invention can be used as a cathode composition for lithium-ion batteries when the electrode active material particles are cathode active material particles, and can be used as an anode composition for lithium-ion batteries when the electrode active material particles are anode material particles.

The cathode active material particles include a composite oxide of lithium and a transition metal {a composite oxido having one kind of transition metal (LiCoO₂, LiNiO₂, LiAlMnO₄, LiMnO₂, LiMn₂C₄, or the like), a composite oxide having two kinds of transition metal elements (for example, LiFeMnO4, LiNi₁₋ₓCoₓO₂, LiMn_{1-y}Co_{y}O₂, LiNi_{1/3}Co_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one example is LiNi_{1/3}Mn_{1/3}Co_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Also, these cathode active material particles may be used alone. Two or more thereof may be used in combination. Herein, the lithium-containing transition metal phosphate may have some of the transition metal sites replaced with other transition metals.

The volume average particle size of the cathode active material particles is preferably from 0.01 to 100 μm, more preferably from 0.1 to 35 μm, and even more preferably from 2 to 30 μm, from the viewpoint of electrical characteristics of the battery.

In this specification, the volume average particle size means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. A MICROTRAC manufactured by Nikkiso Co, Ltd. can be used for measuring the volume average particle size.

A carbon-based material (graphite, non-graphitizable carbon, amorphous carbon, a resin sintered product (for example, a sintered product obtained by sintering and carbonizing a phenol resin, a furan resin, or the like), cokes (for example, a pitch coke, a needle coke, and a petroleum coke), a carbon fiber, or the like), a silicon-based material [silicon, silicon oxide (Siox), a silicon-carbon composite body (a composite body obtained by coating surfaces of carbon particles with silicon and/or silicon carbide, a composite body obtained by coating surfaces of silicon particles or silicon oxide particles with carbon and/or silicon carbide, silicon carbide, or the like), a silicon alloy (a silicon-aluminum alloy, a silicon-lithium alloy, a silicon-nickel alloy, a silicon-iron alloy, a silicon-titanium alloy, a silicon-manganese alloy, a silicon-copper alloy, a silicon-tin alloy, or the like), or the like], a conductive macromolecule (for example, polyacetylene or polypyrrole), a metal (tin, aluminum, zirconium, titanium, or the like), a metal oxide (a titanium oxide, a lithium-titanium oxide, or the like), a metal alloy (for example, a lithium-tin alloy, a lithium-aluminum alloy, or a lithium-aluminum-manganese alloy), or the like, and a mixture of the above and a carbon-based material. Among the above anode active material particles, regarding the anode active material particles that do not contain lithium or lithium-ions in the inside thereof, a part or all of the anode active material particles may be subjected to pre-doping treatment to incorporate lithium or lithium-ions in advance.

The volume average particle size of the anode active material particles is preferably 0.01 to 100 μm, more preferably 0.1 to 60 μm, and still more preferably 2 to 40 μm, from the viewpoint of the electrical characteristics of the battery.

The polymer compound constituting the coating layer is preferably a resin containing a polymer having the acrylic monomer (a) as an essential constituent monomer and the like. Specifically, the polymer compound constituting the coating layer is preferably a polymer of a monomer composition containing acrylic acid (a0) as the acrylic monomer (a). In terms of the above monomer composition, the content of acrylic acid (a0) is preferably 90 wt % or more and 95 wt % or less based on the weight of the entire monomer from the point of flexibility of the coating layer

As the acrylic monomer (a), the polymer compound constituting the coating layer may contain a monomer (a1) having a carboxyl group or an acid anhydride group other than acrylic acid (a0).

Examples of the monomer (a1) having a carboxyl group or an acid anhydride group other than acrylic acid (a0) are monocarboxylic acids with 3 to 15 carbon atoms such as methacrylic acid, crotonic acid, and cinnamic acid; dicarboxylic acids with 4 to 24 carbon atoms such as (anhydrous) maleic acid, fumaric acid, itaconic acid, citraconic acid, and mesaconic acid (anhydrous); Trivalent to tetravalent or higher valence polycarboxylic acids having 6 to 24 carbon atoms such as aconitic acid, etc.

The polymer compound constituting the coating layer may contain a monomer (a2) represented by the following formula (1) as the acrylic monomer (a).

CH₂═C(R¹)COOR² (1)

[In formula (1), R¹ is a hydrogen atom or a methyl group, and R² is a straight chain having 4 to 12 carbon atoms or a branched alkyl group having 3 to 36 carbon atoms.]

In terms of the monomer (a2) shown in formula (1), R¹ represents a hydrogen atom or a methyl group. Preferably, R¹ is a methyl group. R² is preferably a straight chain or branched alkyl group having 4 to 12 carbon atoms, or a branched alkyl group having 13 to 36 carbon atoms.

(a21) Ester Compound in which R² is a Straight Chain or Branched Alkyl Group Having 4 to 12 Carbon Atoms

Examples of the straight chain alkyl group having 4 to 12 carbon atoms include butyl group, pentyl group, hexyl group, heptyl group, octyl group, nonyl group, decyl group, undecyl group, and dodecyl group.

Examples of branched alkyl groups having 4 to 12 carbon atoms include 1-methylpropyl group (sec-butyl group), 2-methylpropyl group, 1,1-dimethylethyl group (tert-butyl group), 1-methylbutyl group, 1-dimethylpropyl group, 1,2-dimethylpropyl group, 2,2-dimethylpropyl group (neopentyl group), 1-methylpentyl group, 2-methylpentyl group, 3-methylpentyl group, 4-methylpentyl group, 1,1-dimethylbutyl group, 1,2-dimethylbutyl group, 1,3-dimethylbutyl group, 2,2-dimethylbutyl group, 2,3-dimethylbutyl group, 1-ethylbutyl group, 2-ethylbutyl group, 1-methylhexyl group, methylhexyl group, 2-methylhexyl group, 4-methylhexyl group, 5-methylhexyl group, 1-ethylpentyl group, 2-ethylpentyl group, 3-ethylpentyl group, 1,1-dimethylpentyl group, 1,2-dimethylpentyl group, 1,3-dimethylpentyl group, 2,2-dimethylpentyl group, 2,3-dimethylpentyl group, 2-ethylpentyl group, 1-methylheptyl group, 2-methylheptyl group, 3-methylheptyl group, 4-methylheptyl group, 5-methylheptyl group, 6-methylheptyl group, 1,1-dimethylhexyl group, 1,2-dimethylhexyl group, 1,3-dimethylhexyl group, 1,4-dimethylhexyl group, 1,5-dimethylhexyl group, 1-ethylhexyl group, 2-ethylhexyl group, 1-methyloctyl group, 2-methyloctyl group, 3-methyloctyl group, 4-Methyloctyl group, 5-methyloctyl group, 6-methyloctyl group, 7-methyloctyl group, 1,1-dimethylheptyl group, 1,2-dimethylheptyl group, 1,3-dimethylheptyl group, 1,4-dimethylheptyl group, 1,5-dimethylheptyl group, 1,6-dimethylheptyl group, 1-ethylheptyl group, 2-ethylheptyl group, 1-methylnonyl group, 2-methylnonyl group, 3-methylnonyl group, 4-Methylnonyl group, 5-methylnonyl group, 6-methylnonyl group, 7-methylnonyl group, 8-methylnonyl group, 1,1-dimethyloctyl group, 1,2-dimethyloctyl group, 1,3-dimethyloctyl group, 1,4-dimethyloctyl group, 1,5-dimethyloctyl group, 1,6-dimethyloctyl group, 1,7-dimethyloctyl group, 1-ethyloctyl group, 2-ethyloctyl group, 1-methyldecyl group, 2-methyldecyl group, 3-methyldecyl group, 4-methyldecyl group, 5-methyldecyl group, 6-methyldecyl group, 7-methyldecyl group, 8-methyldecyl group, 9-methyldecyl group, 1,1-dimethylnonyl group, 1,2-dimethylnonyl group group, 1,3-dimethylnonyl group, 1,4-dimethylnonyl group, 1,5-dimethylnonyl group, 1,6-dimethylnonyl group, 1,7-dimethylnonyl group, 1,8-dimethylnonyl group, 1-ethylnonyl group, 2-ethylnonyl group, 1-methylundecyl group, 2-methylundecyl group, 3-methylundecyl group, 4-methylundecyl group, 5-methylundecyl group, 6-methylundecyl group group, 7-methylundecyl group, 8-methylundecyl group, 9-methylundecyl group, 10-methylundecyl group, 1,1-dimethyldecyl group, 1,2-dimethyldecyl group, 1,3-Dimethyldecyl group, 1,4-dimethyldecyl group, 1,5-dimethyldecyl group, 1,6-dimethyldecyl group, 1,7-dimethyldecyl group, 1,8-dimethyldecyl group, 1,9-dimethyldecyl group group, 1-ethyldecyl group, 2-ethyldecyl group, etc. Among these, 2-ethylhexyl group is particularly preferred.

(a22) Ester Compound in which R² is a Branched Alkyl Group Having 13 to 36 Carbon Atoms

Examples of branched alkyl groups having 13 to 36 carbon atoms include 1-alkylalkyl groups [1-methyldodecyl group, 1-butyleicosyl group, 1-hexyloctadecyl group, 1-octylhexadecyl group, 1-decyltetradecyl group; 1-undecyltridecyl group, etc.], 2-alkylalkyl group [2-methyldodecyl group, 2-hexyloctadecyl group, 2-octylhexadecyl group, 2-decyltetradecyl group, 2-undecyltridecyl group, 2-dodecylhexadecyl group, 2-tridecylpentadecyl group, 2-decyl octadecyl group, 2-tetradecyl octadecyl group, 2-hexadecyl octadecyl group, 2-tetradecyl eicosyl group, 2-hexadecyl eicosyl group groups], 3-34-alkylalkyl groups (3-alkylalkyl group, 4-alkylalkyl group, 5-alkylalkyl group, 32-alkylalkyl group, 33-alkylalkyl group, 34-alkylalkyl group, etc.), or mixed alkyl groups containing one or more branched alkyl groups, such as the residue of an oxo alcohol with the hydroxyl group removed, wherein the oxo alcohol is obtained from Propylene oligomer (7-11 mer), ethylene/propylene (molar ratio 16/1-1/11) oligomer, isobutylene oligomer (7-8 mer), and α-olefin (5-20 carbon atoms) oligomer (4-octamer) and the like.

The polymer compound constituting the coating layer may contain, as the acrylic monomer (a), an ester compound (a3) consisting of a monovalent aliphatic alcohol with 1 to 3 carbon atoms and (meth)acrylic acid.

Examples of the monovalent aliphatic alcohol with 1 to 3 carbon atoms constituting the ester compound (a3) include methanol, ethanol, 1-propanol, and 2-propanol. It is noted that (meth)acrylic acid means acrylic acid or methacrylic acid.

The polymer compound constituting the coating layer is preferably a polymer of a monomer composition containing acrylic acid (a0) and at least one of monomer (a1), monomer (a2), and ester compound (a3). More preferably, the coating resin is a polymer of a monomer composition containing acrylic acid (a0) and at least one of a monomer (a1), an ester compound (a21), and an ester compound (a3). Further preferably, the coating resin is a polymer of a monomer composition containing acrylic acid (a0) and any one of monomer (a1), monomer (a2), and ester compound (a3). Most preferably, the coating resin is a polymer of a monomer composition comprising acrylic acid (a0) and any one of a monomer (a1), an ester compound (a21), and an ester compound (a3).

As the polymer compound constituting the coating layer, examples include a copolymer of acrylic acid and maleic acid using maleic acid as the monomer (a1), a copolymer of acrylic acid and 2-ethylhexyl methacrylate using 2-ethylhexyl methacrylate as the monomer (a2), a copolymer of acrylic acid and methyl methacrylate using methyl methacrylate as the ester compound (a3).

From the point of suppressing volume change of electrode active material particles, the total content of monomer (a1), monomer (a2) and ester compound (a3) is preferably 2.0 to 9.9% by weight, more preferably 2.5 to 7.0% by weight based on the weight of the entire monomer.

Preferably, the polymer compound constituting the coating layer does not contain, as the acrylic monomer (a), a salt (a4) of an anionic monomer having a polymerizable unsaturated double bond and an anionic group.

The structure having the polymerizable unsaturated double bond include a vinyl group, an allyl group, a styrenyl group, and a (meth)acryloyl group.

Examples of the anionic group include a sulfonic acid group and a carboxyl group. An anionic monomer having a polymerizable unsaturated double bond and an anionic group is a compound obtained by a combination of these. Examples include vinylsulfonic acid, allylsulfonic acid, styrenesulfonic acid and (meth)acrylic acid.

Herein, a (meth)acryloyl group means an acryloyl group or a methacryloyl group. Examples of the cations constituting the anionic monomer salt (a4) include lithium ions, sodium ions, potassium ions, and ammonium ions.

In addition, within the range of its physical properties, the polymer compound constituting the coating layer may contain, as the acrylic monomer (a), a radically polymerizable monomer (a5) that is copolymerizable with acrylic acid (a0), monomer (a1), monomer (a2), and ester compound (a3).

The radically polymerizable monomer (a5) is preferably a monomer that does not contain active hydrogen, and the following monomers (a51) to (a58) can be used.

(a51) Hydrocarbyl (Meth)Acrylate Constituting (Meth)Acrylic Acid and One of Straight Chain Aliphatic Monool Having 13 to 20 Carbon Atoms, Alicyclic Monool Having 5 to 20 Carbon Atoms, or Aromatic Aliphatic Monool Having 7 to 20 Carbon Atoms

The monools include (i) straight chain aliphatic monools (tridecyl alcohol, myristyl pentadecyl alcohol, cetyl alcohol, heptadecyl alcohol, stearyl alcohol, nonadecyl alcohol, arachidyl alcohol, etc.), (ii) alicyclic monools (cyclopentyl alcohol, cyclohexyl alcohol, cycloheptyl alcohol, cyclooctyl alcohol, etc.), (iii) aromatic aliphatic monools (benzyl alcohol, etc.), and mixtures of two or more thereof.

(a52) Poly(n=2-30) Oxyalkylene (2-4 Carbon Atoms) Alkyl (1-18 Carbon Atoms) Ether (Meth)Acrylate [10 Mole Adduct (Meth)Acrylate of Ethylene Oxide (Hereinafter Abbreviated as EO) to Methanol, 10 Mole Adduct (Meth)Acrylate of Propylene Oxide (Hereinafter Abbreviated as PO) to Methanol, Etc.]
(a53) Nitrogen-Containing Vinyl Compound
(a53-1) Vinyl Compound Containing Amide Group
(i) (meth)acrylamide compounds having 3 to 30 carbon atoms, such as N, N-dialkyl (1 to 6 carbon atoms) or diallkyl (7 to 15 carbon atoms) (meth)acrylamide (N, N-dimethylacrylamide, N,N-dibenzylacrylamide, etc.), diacetone acrylamide
(ii) Vinyl compounds containing an amide group having 4 to 20 carbon atoms, excluding the above (meth)acrylamide compounds, such as N-methyl-N-vinylacetamide, cyclic amide [pyrrolidone compounds (having 6 to 13 carbon atoms, such as N-vinylpyrrolidone, etc.)]
   (a53-2) (Meth)Acrylate Compound
(i) Dialkyl (1 to 4 carbon atoms) aminoalkyl (1 to 4 carbon atoms) (meth)acrylate [N, N-dimethylaminoethyl (meth)acrylate, N, N-diethylaminoethyl (meth)acrylate, t-Butylaminoethyl (meth)acrylate, morpholinoethyl (meth)acrylate, etc.]
(ii) (meth)acrylate containing quaternary ammonium group {(meth)acrylate containing tertiary amino group [N, N-dimethylaminoethyl (meth)acrylate, N, N-diethylaminoethyl (meth)acrylate, etc.] quaternized compounds (quaternized using a quaternizing agent such as methyl chloride, dimethyl sulfate, benzyl chloride, dimethyl carbonate, etc.), etc.}
   (a53-3) Vinyl Compound Containing Heterocycle

Pyridine compounds (7 to 14 carbon atoms, e.g. 2- or 4-vinylpyridine), imidazole compounds (5 to 12 carbon atoms, e.g. N-vinylimidazole), pyrrole compounds (6 to 13 carbon atoms, e.g. N-vinylpyrrole), pyrrolidone compound (6 to 13 carbon atoms, e.g. N-vinyl-2-pyrrolidone)

(a53-4) Vinyl Compound Containing Nitrile Groups

Vinyl compound containing nitrile groups having 3 to 15 carbon atoms, such as (meth)acrylonitrile, cyanostyrene, cyanoalkyl (1 to 4 carbon atoms) acrylates

(a53-5) Vinyl Compound Containing Other Nitrogen Vinyl Compound Containing Nitro Group (8 to 16 Carbon Atoms, Such as Nitrostyrene), Etc.
(a54) Vinyl Hydrocarbon
(a54-1) Aliphatic Vinyl Hydrocarbon

Olefins having 2 to 18 carbon atoms or more (ethylene, propylene, butene, isobutylene, pentene, heptene, diisobutylene, octene, dodecene, octadecene, etc.), dienes having 4 to 10 carbon atoms or more (butadiene, isoprene, 1,4-pentadiene, 1,5-hexadiene, 1,7-octadiene, etc.) etc.

(a54-2) Alicyclic Vinyl Hydrocarbon

Cyclic unsaturated compounds having from 4 to 18 carbon atoms or more, such as cycloalkenes (e.g. cyclohexene), (di)cycloalkadienes [e.g. (di)cyclopentadiene], terpenes (e.g. pinene and limonene), indenes

(a54-3) Aromatic Vinyl Hydrocarbon

Aromatic unsaturated compounds having 8 to 20 carbon atoms or more, such as styrene, α-methylstyrene, vinyltoluene, 2,4-dimethylstyrene, ethylstyrene, isopropylstyrene, butylstyrene, phenylstyrene, cyclohexylstyrene, benzylstyrene

(a55) Vinyl Ester

Aliphatic vinyl esters [4 to 15 carbon atoms, such as alkenyl esters of aliphatic carboxylic acids (mono- or dicarboxylic acids) (such as vinyl acetate, vinyl propionate, vinyl butyrate, diallyl adipate, isopropenyl acetate, vinyl methoxy acetate)]

Aromatic vinyl esters [9 to 20 carbon atoms, such as alkenyl esters of aromatic carboxylic acids (mono- or dicarboxylic acids) (such as vinyl benzoate, diallyl phthalate, methyl-4-vinyl benzoate), aromatic ring-containing aliphatic carboxylic acids ester (e.g. acetoxystyrene)]

(a56) Vinyl Ether

Aliphatic vinyl ethers [3 to 15 carbon atoms, such as vinyl alkyl (1 to 10 carbon atoms) ethers (vinyl methyl ether, vinyl butyl ether, vinyl 2-ethylhexyl ether, etc.), vinyl alkoxy (1 to 6 carbon atoms) alkyl (carbon atoms 1-4) Ethers (vinyl-2-methoxyethyl ether, methoxybutadiene, 3,4-dihydro-1,2-pyran, 2-butoxy-2′-vinyloxydiethyl ether, vinyl-2-ethylmercaptoethyl ether, etc.)), poly(2-4) (meth)allyloxyalkane (carbon number 2-6) (diallyloxyethane, triallyloxyethane, tetraallyloxybutane, tetramethallyloxyethane, etc.)], aromatic vinyl ether (8 to 20 carbon atoms, e.g. vinyl phenyl ether, phenoxystyrene)

(a57) Vinyl Ketone

Aliphatic vinyl ketones (4 to 25 carbon atoms, e.g. vinyl methyl ketone, vinyl ethyl ketone), aromatic vinyl ketones (9 to 21 carbon atoms, e.g. vinyl phenyl ketone)

(a58) Unsaturated Dicarboxylic Acid Diester Unsaturated

Dicarboxylic acid diester having 4 to 34 carbon atoms, for example, dialkyl fumarate (two alkyl groups are linear, branched or alicyclic groups having 1 to 22 carbon atoms), dialkyl maleate (two alkyl groups are linear, branched or alicyclic groups having 1 to 22 carbon atoms)

When the radically polymerizable monomer (a5) is contained, the content thereof based on the weight of all monomers is preferably 0.1 to 3.0 wt %.

The polymer compound constituting the coating layer is preferably a polymer containing methacrylic acid, methyl methacrylate, and 2-ethylhexyl methacrylate as essential constituent monomers from the perspective of suppressing the influence of volume change of coated electrode active material particles so as to impart conformability (flexibility) to the coating layer.

A preferable lower limit of the weight average molecular weight of polymer compound constituting the coating layer is 3,000, a more preferable lower limit is 5,000, and a still more preferable lower limit is 7,000. On the other hand, a preferable upper limit of the weight average molecular weight of coating resin is 100,000, and a more preferable upper limit is 70,000.

The weight average molecular weight of the polymer compound constituting the coating layer can be obtained by gel permeation chromatography (hereinafter abbreviated as GPC) measurement under the following conditions.
Device: Alliance GPC V2000 (commercially available from Waters)
Solvent: ortho-dichlorobenzene, DMF, THF
Standard substance: polystyrene
Sample concentration: 3 mg/ml
Column stationary phase: PLgel 10 μm, MIXED-B 2 columns in series (commercially available from Polymer Laboratories Ltd.) Column temperature: 135° C.

The polymer compound constituting the coating layer can be produced using a known polymerization initiator {azo initiator [2,2′-azobis(2-methylpropionitrile), 2,2′-azobis(2,4-dimethylvaleronitrile), 2,2′-azobis(2-methylbutyronitrile), etc.], peroxide initiator (benzoyl peroxide, di-t-butyl peroxide, lauryl peroxide, etc.) or the like} by a known polymerization method (bulk polymerization, solution polymerization, emulsion polymerization, suspension polymerization, etc.).

In order to adjust the weight-average molecular weight to be within a preferable range, the amount of the polymerization initiator used based on the total weight of the monomers is preferably 0.01 to 5 wt %, more preferably 0.05 to 2 wt %, and still more preferably 0.1 to 1.5 wt %, and the polymerization temperature and the polymerization time are adjusted depending on the type of the polymerization initiator and the like, and polymerization is performed at a polymerization temperature of preferably-5 to 150° C., (more preferably 30 to 120° C.) for a reaction time of preferably 0.1 to 50 hours (more preferably 2 to 24 hours).

Examples of solvents used in the solution polymerization include esters (with 2 to 8 carbon atoms, for example, ethyl acetate and butyl acetate), alcohols (with 1 to 8 carbon atoms, for example, methanol, ethanol and octanol), hydrocarbons (with 4 to 8 carbon atoms, for example, n-butane, cyclohexane and toluene), amides (for example, N, N-dimethylformamide (hereafter abbreviated as DMF)) and ketones (with 3 to 9 carbon atoms, for example, methyl ethyl ketone), and in order to adjust the weight-average molecular weight to be within a preferable range, the amount thereof used based on the total weight of the monomers is preferably 5 to 900 wt %, more preferably 10 to 400 wt %, and still more preferably 30 to 300 wt %, and the monomer concentration is preferably 10 to 95 wt %, more preferably 20 to 90 wt %, and still more preferably 30 to 80 wt %.

Examples of dispersion media for emulsion polymerization and suspension polymerization include water, alcohols (for example, ethanol), esters (for example, ethyl propionate), and light naphtha, and examples of emulsifiers include (C10-C24) higher fatty acid metal salts (for example, sodium oleate and sodium stearate), (C10-C24) higher alcohol sulfate metal salts (for example, sodium lauryl sulfate), ethoxylated tetramethyldecynediol, sodium sulfoethyl methacrylate, and dimethylaminomethyl methacrylate. In addition, polyvinyl alcohol, polyvinylpyrrolidone or the like may be added as the stabilizer.

The monomer concentration of the solution or dispersion liquid is preferably 5 to 95 wt %, more preferably 10 to 90 wt %, and still more preferably 15 to 85 wt %, and the amount of the polymerization initiator used based on the total weight of the monomers is preferably 0.01 to 5 wt %, and more preferably 0.05 to 2 wt %.

During polymerization, a known chain transfer agent, for example, a mercapto compound (dodecyl mercaptan, n-butyl mercaptan, etc.) and/or a halogenated hydrocarbon (carbon tetrachloride, carbon tetrabromide, benzyl chloride, etc.), can be used.

The polymer compound constituting the coating layer may be a crosslinked polymer obtained by cross-linking said polymer with a cross-linking agent (A′) having a reactive functional group that reacts with a carboxyl group {preferably a polyepoxy compound (a′1) [polyglycidyl ether (bisphenol A diglycidyl ether, propylene glycol diglycidyl ether, glycerin triglycidyl ether, etc.), polyglycidylamine (N, N-diglycidylaniline and 1,3-bis(N, N-diglycidylaminomethyl)) and the like] and/or a polyol compound (a′2) (ethylene glycol, etc.)}.

Examples of methods of cross-linking a polymer compound constituting the coating layer using a cross-linking agent (A′) include a method of coating electrode active material particles with a polymer compound constituting the coating layer and then performing cross-linking. Specifically, a method in which electrode active material particles and a resin solution containing a polymer compound are mixed, the solvent is removed to produce coated active material particles, and a solution containing the cross-linking agent (A′) is then mixed with the coated active material particles and heated, and thus the solvent is removed, a cross-linking reaction is caused, and a reaction in which the polymer compound constituting the coating layer is cross-linked with the cross-linking agent (A′) is caused on the surface of electrode active material particles may be exemplified.

The heating temperature is adjusted depending on the type of the cross-linking agent, and when the polyepoxy compound (a′1) is used as the cross-linking agent, the heating temperature is preferably 70° C. or higher, and when the polyol compound (a′2) is used, the heating temperature is preferably 120° C. or higher.

The coating layer preferably contains a conductive assistant from the viewpoint of imparting conductivity.

Examples of conductive assistants include [aluminum, metals stainless steel (SUS), silver, gold, copper, titanium, etc.], carbon [graphite, carbon black (acetylene black, ketjen black, furnace black, channel black, thermal lamp black, etc.) and the like], and mixtures thereof. However, the conductive assistant is preferably the first conductive filler described below, that is, a conductive filler having an aspect ratio of 10 or less.

On the other hand, it is preferable that the coating layer does not contain a second conductive filler (conductive filler having an aspect ratio of 15 or more), which will be described later. When the coating layer contains the conductive filler with an aspect ratio of 15 or more, the aggregates of the first conductive filler and the second conductive filler may be formed in the coating layer.

The ratio of the polymer compound and the conductive assistant constituting the coating layer is not particularly limited. However, from the viewpoint of internal resistance of the battery, etc., the weight ratio of the polymer compound (resin solid content weight) constituting the coating layer to the conductive assistant is preferably 1:0.01 to 1:50, and more preferably 1:0.2 to 1:3.0.

The coating layer preferably contains ceramic particles from the viewpoint of suppressing side reactions between the electrolytic solution and the coated electrode active material particles.

Examples of ceramic particles include metal carbide particles, metal oxide particles, and glass ceramic particles.

Examples of metal carbide particles include silicon carbide (SIC), tungsten carbide (WC), molybdenum carbide (MO₂C), titanium carbide (TiC), tantalum carbide (TaC), niobium carbide (NbC), vanadium carbide (VC), and zirconium carbide (ZrC).

Examples of metal oxide particles include particles of zinc oxide (ZnO), aluminum oxide (Al₂O₃), silicon dioxide (SiO₂), tin oxide (SnO₂), titania (TiO₂), zirconia (ZrO₂), indium oxide (In₂O₃), Li₂B₄O₇, Li₄Ti₅O₁₂, Li₂Ti₂O₅, LiTaO₃, LiNbO₃, LiAlO₂, Li₂ZrO₃, Li₂WO₄, Li₂TiO₃, Li₃PO₄, Li₂MoO₄, Li₃BO₃, LiBO₂, Li₂CO₃, Li₂SiO₃, and a perovskite oxide represented by ABO₃ (where, A is at least one selected from the group consisting of Ca, Sr, Ba, La, Pr and Y, and B is at least one selected from the group consisting of Ni, Ti, V, Cr, Mn, Fe, Co, Mo, Ru, Rh, Pd and Re).

As the metal oxide particles, in order to suitably inhibit a side reaction between the electrolytic solution and the coated electrode active material particles, Zinc oxide (ZnO), aluminum oxide (Al₂O₃), silicon dioxide (SiO₂), and lithium tetraborate (Li₂B₄O₇) are preferable.

As the ceramic particles, in order to suitably inhibit a side reaction that occurs between the electrolytic solution and the coated electrode active material particles, glass ceramic particles are preferable. These may be used alone or two or more thereof may be used in combination.

The glass ceramic particles are preferably a lithium-containing phosphate compound having a rhombohedral crystal system and a chemical formula thereof is represented by LiₓM″₂P₃O₁₂ (X=1 to 1.7).

Here, M″ is one or more elements selected from the group consisting of Zr, Ti, Fe, Mn, Co, Cr, Ca, Mg, Sr, Y, Sc, Sn, La, Ge, Nb, and Al. In addition, some P may be replaced with Si or B, and some 0 may be replaced with F, Cl like. For example, Li_{1.15}Ti_{1.85}Al_{2.15}Si_{0.05}P_{2.95}O₁₂, Li_{1.2}Ti_{1.8}Al_{2.1}Ge_{0.1}Si_{0.05}P_{2.95}O₁₂ or the like can be used.

In addition, materials with different compositions may be mixed or combined, and the surface may be coated with a glass electrolyte or the like. Alternatively, it is preferable to use glass ceramic particles that precipitate a crystal phase of a lithium-containing phosphate compound having a NASICON type structure according to a heat treatment. Examples of glass electrolytes include the glass electrolyte described in Japanese Patent Application Publication No. 2019-96478.

Here, the mixing proportion of Li₂O in the glass ceramic particles is preferably 8 mass % or less in terms of oxide.

In addition to a NASICON type structure, a solid electrolyte which is composed of Li, La, Mg, Ca, Fe, Co, Cr, Mn, Ti, Zr, Sn, Y, Sc, P, Si, O, In, Nb, or F, has a LISICON type, perovskite type, β-Fe₂(SO₄)₃ type, or LisIn₂(PO₄)₃ type crystal structure, and transmits 1×10⁻⁵ S/cm or more of Li ions at room temperature may be used.

The above ceramic particles may be used alone or two or more thereof may be used in combination.

In consideration of the energy density and electrical resistance value, the volume average particle size of the ceramic particles is preferably 1 to 1, 200 nm, more preferably 1 to 500 nm, and still more preferably 1 to 150 nm.

The weight proportion of the ceramic particles is preferably 1.0 to 5.0 wt % based on the weight of the coated electrode active material particles.

With the ceramic particles contained in the above range, side reactions between the electrolytic solution and the coated electrode active material particles can be suitably suppressed.

The weight proportion of the ceramic particles is preferably 2.0 to 4.0 wt % based on the weight of the coated electrode active material particles.

The method of producing coated electrode active material particles for lithium-ion batteries includes a step of removing a solvent after mixing electrode active material particles, a polymer compound, a conductive assistant, ceramic particles, and an organic solvent.

The organic solvent is not particularly limited as long as it can dissolve the polymer compound, and any known organic solvent can be appropriately selected and used.

In the method of producing coated electrode active material particles, first, electrode active material particles, a polymer compound constituting the coating layer, a conductive assistant, and ceramic particles are mixed in the organic solvent. In a case when the electrode particles, the polymer compound constituting the coating layer, the conductive assistant, and the ceramic particles are mixed, the order is not particularly limited. For example, a resin composition consisting of a polymer compound constituting the coating layer, a conductive assistant, and ceramic particles may be further mixed with the electrode active material particles, wherein the resin compound was pre-mixed. The electrode active material particles, the polymer compound constituting the coating layer, the conductive assistant, and the ceramic particles may be mixed at the same time. A polymer compound constituting the coating layer may be mixed with the electrode active material particles. Further, a conductive assistant and ceramic particles may be mixed therein.

The coated electrode material particles can be obtained by covering electrode active material particles with a coating layer containing a polymer compound, a conductive assistant and ceramic particles, for example, while the electrode active material particles are put into a universal mixer and stirred at 30 to 500 rpm, the particles can be obtained. when resin solution containing a polymer compound that forms the coating layer is added dropwise over 1 to 90 minutes and mixed, the conductive assistant and the ceramic particles are mixed, the temperature is raised to 50 to 200° C. with stirring, the pressure is reduced to 0.007 to 0.04 MPa, the sample is then left for 10 to 150 minutes, and the solvent is removed.

The mixing ratio of the electrode active material particles, and the resin composition consisting of a polymer compound constituting the coating layer, a conductive assistant, and ceramic particles is not particularly limited, and the weight ratio of the electrode active material particles: the resin composition is preferably 1:0.001 to 0.1.

At least a part of the surface of the electrode active material particles is covered with a resin layer.

From the viewpoint of cycle characteristics, the coverage of the electrode active material particles is preferably 30 to 95% as obtained by the following calculation formula.

Coverage (%)={1−[BET specific surface area of coated electrode active material particles/(BET specific surface area of electrode active material particles×weight proportion of electrode active material particles contained in coated electrode active material particles+BET specific surface area of conductive assistant×weight proportion of conductive assistant contained in coated electrode active material particles+BET specific surface area of ceramic particles×weight proportion of ceramic particles contained in coated electrode active material particles)]}×100

### (First Conductive Filler)

The first conductive filler has an aspect ratio of 10 or less.

The first conductive filler is not particularly limited as long as it satisfies the above aspect ratio. Examples of the first conductive filler include metals [aluminum, stainless steel (SUS), silver, gold, copper, titanium, etc.], carbon [graphite (flake graphite (UP)), and carbon black (acetylene black (AB), chain black (KB), furnace black, channel black, thermal lamp black, etc.), and mixtures thereof.

Among them, from the viewpoint of suitably satisfying the aspect ratio of the first conductive filler and suitably reducing the tackiness of the surface of the coating layer, acetylene black (AB), Ketjen black (KB), or flaky graphite (UP) is preferred.

The first conductive filler preferably has an aspect ratio of 5 or less, more preferably 3 or less from the viewpoint of reducing the tackiness of the surface of the coating layer and suppressing the formation of aggregates with the second conductive filler described below.

In this specification, the term “aspect ratio” refers to the average value of the ratio of the long axis (y) to the short axis (x) [long axis (y)/short axis (x)], when measuring the short axis (x) and long axis (y) of particles observed in several to several dozen fields of view by using observation means such as a scanning electron microscope (SEM) or a transmission electron microscope (TEM).

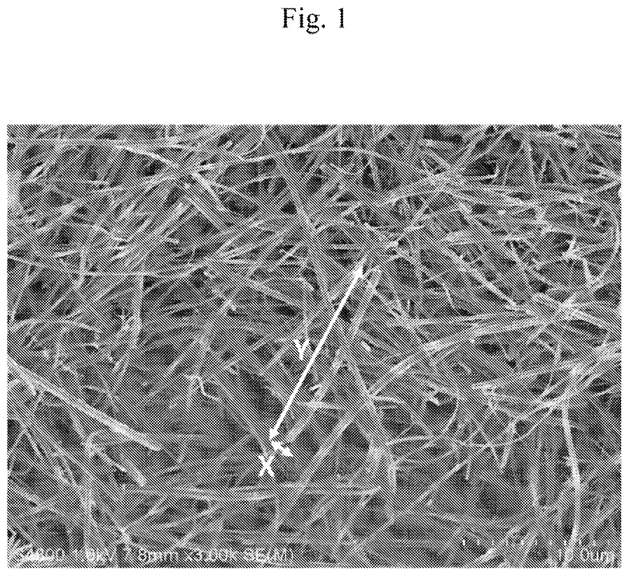

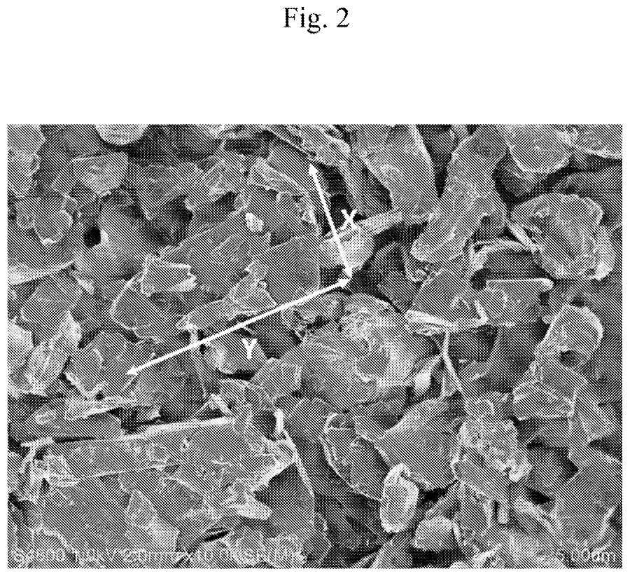

For example, FIG. 1 is a SEM photograph of carbon nanofibers (CNF), and FIG. 2 is a SEM photograph of flaky graphite (UP). As shown in FIGS. 1 and 2, 20 particles are randomly selected from the SEM photographs. And then the short axis (x) and long axis (y) of each may be measured, and the average value of the ratio of the long axis (y) to the short axis (x) [long axis (y)/short axis (x)] may be calculated.

The average particle diameter of the first conductive filler is not particularly limited, but from the viewpoint of the electrical characteristics of the battery, it is preferably about 0.01 to 10 μm. In this specification, the “particle size of the conductive assistant” is the maximum distance L among the distances between arbitrary two points on the outline of the conductive assistant. As the value of “average particle size”, the value calculated as an average value of the particle sizes of the particles observed in several to several tens of fields of view using an observation device such as a scanning electron microscope (SEM) or a transmission electron microscope (TEM) is used.

In the first mixing step, the first conductive filler to be mixed is preferably 0.1 to 10 wt %, and is more preferably 0.2 to 5 wt % based on the weight of the coated electrode active material particles for lithium-ion batteries.

If the first conductive filler is less than 0.1 wt %, the tackiness of the surface of the coating layer may not be sufficiently reduced.

If the first conductive filler exceeds 10 wt %, the first conductive filler may aggregate, or the second conductive filler described below may not be able to contact the coating layer and may aggregate outside.

### (Powder for Electrodes)

In the first mixing step, a powder for electrodes can be obtained by mixing the coated electrode active material particles for lithium-ion batteries, in which at least a part of the surface of the electrode active material particle is coated with a polymer compound, with a first conductive filler having an aspect ratio of 10 or less.

The mixing method in the first mixing step can be carried out using, for example, a dispersing machine or a kneading machine such as a three-roller mill, a ball mill, or a planetary ball mill.

Specifically, a planetary stirring type mixing and kneading device {Awatori Rentaro (registered trademark) [manufactured by Shinky Co., Ltd.]} can be applicable.

The rotational speed during mixing is preferably 1000 to 3000 rpm, more preferably 1500 to 2500 rpm, for example.

The mixing time is preferably 1 to 30 minutes, more preferably 2 to 15 minutes.

### <Second Mixing Step>

The second mixing step is a step of obtaining an electrode composition, which was obtained in the first mixing step, by mixing the powder for electrodes with a second conductive filler having an aspect ratio of 15 or more.

### (Second Conductive Filler)

The second conductive filler has an aspect ratio of 15 or more.

The second conductive filler is not particularly limited as long as it satisfies the above aspect ratio. Examples of the second conductive filler include metals [aluminum, stainless steel (SUS), silver, gold, copper, titanium, etc.], carbon [graphite (flake graphite (UP)), and carbon black (furnace black, channel black, thermal lamp black, etc.), carbon nanofibers (CNF), etc.], and mixtures thereof.

Among them, from the viewpoint of suitably satisfying the aspect ratio of the second conductive filler and suitably reducing the tackiness of the surface of the coating layer, carbon nanofibers (CNF) are preferred.

The second conductive filler preferably has an aspect ratio of 20 or more, more preferably 25 or more from the viewpoint of suitably forming an electron conduction path and suitably imparting electron conductivity.

In the second mixing step, the second conductive filler to be mixed is preferably 0.05 to 10 wt %, and is more preferably 0.1 to 5 wt %, based on the weight of the electrode powder from the viewpoint of suppressing agglomeration of the second conductive filler and imparting suitable electronic conductivity.

The mixing method in the second mixing step can be carried out using, for example, a dispersing machine or a kneading machine such as a three-roller mill, a ball mill, or a planetary ball mill.

Specifically, a planetary stirring type mixing and kneading device {Awatori Rentaro [manufactured by Shinky Co., Ltd.]} can be applicable.

The rotational speed during mixing is preferably 1000 to 3000 rpm, more preferably 1500 to 2500 rpm, for example. The mixing time is preferably 1 to 30 minutes, more preferably 2 to 15 minutes.

### (Electrode Composition)

The electrode composition obtained by the method of manufacturing an electrode composition for lithium-ion batteries of the present invention can suppress the formation of aggregates on the surface of the coating layer. Therefore, good fluidity can be imparted to the electrode composition for lithium-ion batteries, and deterioration of battery performance can be suppressed.

It is noted that whether or not aggregates are formed on the surface of the coating layer can be observed based on the state of the surface of the coating layer by using an observation device such as a scanning electron microscope (SEM) or a transmission electron microscope (TEM).

In the electrode composition, the first conductive filler is preferably 0.2 to 5 wt % based on the weight of the electrode composition from the viewpoint of suitably suppressing the formation of aggregates on the surface of the coating layer.

In the electrode composition, the second conductive filler is preferably 0.1 to 5 wt % based on the weight of the electrode composition from the viewpoint of suppressing aggregation of the second conductive filler and suitably imparting electronic conductivity.

### <Electrode for Lithium-Ion Batteries>

The electrode composition for lithium-ion batteries obtained by the method of manufacturing an electrode composition for lithium-ion batteries of the present invention can be used for manufacturing an electrode for lithium-ion batteries. The electrode for lithium-ion batteries includes an electrode active material layer containing an electrode composition for lithium-ion batteries and an electrolytic solution having an electrolyte and a solvent.

The amount of the coated electrode active material particles contained in the electrode active material layer is preferably 40 to 95 wt % based on the weight of the electrode active material layer and is more preferably 60 to 90 wt % from the viewpoint of dispersibility of electrode active material particles and electrode formability.

As the electrolyte, electrolytes electrolytic solutions can be used, and for example, lithium salts of inorganic anions such as LiPF₆, LIBF₄, LASbF₆, LiAsF₆, LiClO₄, and LiN(FSO₂)₂, and lithium salts of organic anions such as LiN(CF₃SO₂)₂, LiN(CF₂F₅SO₂)₂, and LiC(CF₃SO₂)₃ may be exemplified. Among these, LiN(FSO₂)₂ is preferable in consideration of the battery output and charging and discharging cycle characteristics.

As the solvent, non-aqueous solvents used in known electrolytic solutions can be used, and for example, lactone compounds, cyclic or chain carbonates, chain carboxylates, cyclic or chain ethers, phosphate esters, nitrile compounds, amide compounds, sulfone, sulfolane and mixtures thereof can be used.

Examples of lactone compounds include 5-membered ring (γ-butyrolactone, γ-valerolactone, etc.) and 6-membered ring (5-valerolactone, etc.) lactone compounds.

Examples of cyclic carbonates include propylene carbonate, ethylene carbonate (EC) and butylene carbonate (BC).

Examples of chain carbonates include dimethyl carbonate (DMC), methyl ethyl carbonate (MEC), diethyl carbonate (DEC), methyl-n-propyl carbonate, ethyl-n-propyl carbonate and di-n-propyl

Examples of chain carboxylates include methyl acetate, ethyl acetate, propyl acetate and methyl propionate.

Examples of cyclic ethers include tetrahydrofuran, tetrahydropyran, 1,3-dioxolane and 1,4-dioxane. Examples of chain ethers include dimethoxymethane and 1,2-dimethoxyethane.

Examples of phosphate esters include trimethyl phosphate, triethyl phosphate, ethyldimethyl phosphate, diethylmethyl phosphate, tripropyl phosphate, tributyl phosphate, tri (trifluoromethyl) phosphate, tri (trichloromethyl) phosphate, tri (trifluoroethyl) phosphate, tri (triperfluoroethyl) phosphate, 2-ethoxy-1,3,2-dioxaphospholan-2-one, 2-trifluoroethoxy-1,3,2-dioxaphospholan-2-one and 2-methoxyethoxy-1,3,2-dioxaphospholan-2-one.

Examples of nitrile compounds include acetonitrile. Examples of amide compounds include DMF. Examples of sulfones include dimethyl sulfone and diethyl sulfone.

These solvents may be used alone or two or more thereof may be used in combination.

The concentration of the electrolyte in the electrolytic solution is preferably 1.2 to 5.0 mol/L, more preferably 1.5 to 4.5 mol/L, still more preferably 1.8 to 4.0 mol/L, and particularly preferably 2.0 to 3.5 mol/L.

Since such an electrolytic solution has an appropriate viscosity, it can form a liquid film between the coated electrode active material particles, and impart a lubrication effect (an ability to adjust the position of coated active material particles) to the coated electrode active material particles.

The electrode active material layer may further contain a conductive assistant in addition to the conductive assistant that is contained as necessary in the coating layer of the above coated electrode active material particles. While the conductive assistant that is contained as necessary in the coating layer is integrated with the coated electrode active material particles, the conductive assistant contained in the electrode active material layer can be distinguished in that it is contained separately from the coated electrode active material particles.

As the conductive assistant that may be included in the electrode active material layer, those explained in [First conductive filler, second conductive filler] can be used.

When the electrode active material layer contains a conductive assistant, the total content of the conductive assistant contained in the electrode and the conductive assistant contained in the coating layer based on the weight of the electrode active material layer excluding the electrolytic solution is preferably less than 4 wt % and more preferably less than 3 wt. On the other hand, the total content of the conductive assistant contained in the electrode and the conductive assistant contained in the coating layer based on the weight of the electrode active material layer excluding the electrolytic solution is preferably 2.5 wt % or more.

The electrode active material layer preferably does not contain a binder.

Here, in this specification, the binder refers to an agent that cannot reversibly fix the electrode active material particles to each other and the electrode active material particles to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene butadiene rubber, polyethylene and polypropylene may be exemplified.

These binders are used by being dissolved or dispersed in a solvent, and are solidified by volatilizing and distilling off the solvent to irreversibly fix the electrode active material particles to each other and the electrode active material particles to the current collector.

The electrode active material layer may contain an adhesive resin. The adhesive resin is a resin that does not solidify and has adhesiveness even if the solvent component is volatilized and dried, and is a material different and distinguished from the binder.

In addition, while the coating layer constituting the coated electrode active material particles is fixed to the surface of electrode active material particles, the adhesive resin reversibly fixes the surfaces of the electrode active material particles to each other. The adhesive resin can be easily separated from the surface of electrode active material particles, but the coating layer cannot be easily separated.

Therefore, the coating layer and the adhesive resin are different materials.

[symbol] sive resin, polymers which contain at least one low Tg monomer selected from the group consisting of vinyl acetate, 2-ethylhexyl acrylate, 2-ethylhexyl methacrylate, butyl acrylate and butyl methacrylate as an essential constituent monomer, and in which the total weight proportion of the low Tg monomers based on the total weight of the constituent monomers is 45 wt % or more may be exemplified.

When the adhesive resin is used, it is preferable to use 0.01 to 10 wt % of the adhesive resin based on the total weight of the electrode active material particles.

As for the electrode for lithium-ion batteries of this invention, the weight proportion of the polymer compound contained in the electrode for lithium-ion batteries based on the weight of the electrode for lithium-ion batteries is 1 to 10 wt %.

Here, the “polymer compound” refers to a polymer compound constituting a coating layer, a binder and an adhesive resin, and in the electrode for lithium-ion batteries, the total weight proportion of the polymer compound constituting the coating layer and the adhesive resin is equal to the above “weight proportion of the polymer compound” and contains no binder (0 wt %).

In terms of the electrode for lithium-ion batteries, the electrode active material layer is formed of a non-bound component of the coated electrode active material particles for lithium-ion batteries.

Herein, it is called a non-bound component because the position of the electrode active material particles is not fixed in the electrode active material layer, and the electrode active material particles and the electrode active material particles and the current collector are not irreversibly fixed.

When the electrode active material layer is a non-bound component, this is preferable because, since the electrode active material particles are not irreversibly fixed to each other, it is possible to separate the electrode active material particles from each other without causing breakage at the interface, and even if stress is applied to the electrode active material layer, the movement of the electrode active material particles can prevent the electrode active material layer from being broken.

The electrode active material layer which is a non-bound component can be obtained by a method such as using a electrode active material layer composition containing electrode active material particles, an electrolytic solution or the like and not containing a binder as the electrode active material layer.

In consideration of battery performance, the thickness of the electrode active material layer is preferably 150 to 600 μm and more preferably 200 to 550 μm.

As for the electrode for lithium-ion batteries, for example, a powder (composition for an electrode active material layer) obtained by mixing the electrode composition for lithium-ion batteries and, if necessary, a conductive assistant, etc., can also be produced by pouring the powder in an electrolytic solution after applying the powder to the current collector and pressing it with a press machine to form an electrode active material layer.

In addition, it is fine that the composition for an electrode active material layer is applied onto a release film and pressed to form an electrode active material layer, and after the electrode active material layer is transferred to a current collector, the electrolytic solution may be injected.

In addition, the electrodes for lithium-ion batteries may also be made when a frame member is placed on the current collector, and the composition for an electrode active material layer is filled inside the frame member to have the same thickness as the frame member.

Examples of materials constituting the current collector include metal materials such as copper, aluminum, titanium, stainless steel, nickel and alloys thereof, and calcined carbon, conductive polymer materials, and conductive glass.

The shape of the current collector is not particularly limited, and a sheet-like current collector made of the above material and a deposition layer including fine particles composed of the above material may be used.

The thickness of the current collector is not particularly limited, but is preferably 50 to 500 μm.

The electrode for lithium-ion batteries further comprises a current collector, and the electrode active material layer is preferably provided on the surface of the current collector. For example, the electrode for lithium-ion batteries preferably comprises a resin current collector made of a conductive polymer material, and the electrode active material layer is provided on the surface of the resin current collector.

As the conductive polymer material constituting the resin current collector, for example, those obtained by adding a conducting agent to a resin can be used.

As the conducting agent constituting the conductive polymer material, the same conductive assistant which is an optional component for the coating layer can be preferably used.

Examples of resins constituting the conductive polymer material include polyethylene (PE), polypropylene (PP), polymethylpentene (PMP), polycycloolefin (PCO), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA), polyvinylidene fluoride (PVdF), epoxy resins, silicone resins and mixtures thereof.

In consideration of electrical stability, polyethylene (PE), polypropylene (PP), polymethylpentene (PMP) and polycycloolefin (PCO) are preferable, and polyethylene (PE), polypropylene (PP) and polymethylpentene (PMP) are more preferable.

The resin current collector can be obtained by known methods described in Japanese Patent Application Publication No. 2012-150905, WO 2015/005116 and the like.

The frame member is not particularly limited as long as it is made of a material that is durable against the electrolytic solution, but a polymer material is preferable, and a thermosetting polymer material is more preferable. Specifically, epoxy resins, polyolefin resins, polyester resins, polyurethane resins, polyvinidene fluoride resins, etc. may be used.

### <Lithium-Ion Battery>

An electrode for lithium-ion batteries can be obtained by combining the above electrode with an electrode that serves as a counter electrode, housing it in a cell container together with a separator, injecting an electrolytic solution, and sealing the cell container.

In addition, a lithium-ion battery can be obtained by forming an electrode for lithium-ion batteries on one side of a current collector, forming an opposite pole of an electrode for lithium-ion batteries on the other side to produce a bipolar type electrode, laminating the bipolar type electrode and a separator, housing it in a cell container, injecting an electrolytic solution, and sealing the cell container.

Examples of separators include known separators for lithium-ion batteries such as polyethylene or polypropylene porous films, laminated films of a porous polyethylene film and a porous polypropylene, non-woven fabrics composed of synthetic fibers (polyester fibers, aramid fibers, etc.), glass fibers or the like, and those with ceramic fine particles such as silica, alumina, and titania adhered to their surfaces.

### EXAMPLES

Next, the present invention will be described in detail with reference to examples, but the present invention is not limited to the examples as long as it does not depart from the spirit of the present invention. Here, unless otherwise specified, parts means parts by weight, and % means wt %.

### [Production of Electrolytic Solution]

An electrolytic solution was prepared by dissolving LiFSI at a proportion of 2.0 mol/b in a solvent mixture containing ethylene carbonate (EC) and propylene carbonate (PC) (volume ratio of 1:1).

[Production of Polymer Compound (A) that Coats Cathode Electrode Active Material Particles]

150 parts of DMF was put into a 4-neck flask including a stirrer, a thermometer, a reflux cooling tube, a dropping funnel and a nitrogen gas inlet tube, and the temperature was raised to 75° C. Next, a monomer composition in which 91 parts of acrylic acid, 9 parts of methyl methacrylate and 50 parts of DMF were mixed and an initiator solution in which 0.3 parts of 2,2′-azobis(2,4-dimethylvaleronitrile) and 0.8 parts of 2,2′-azobis(2-methylbutyronitrile) were dissolved in 30 parts of DMF were continuously added dropwise over 2 hours through a dropping funnel with stirring while blowing nitrogen into the 4-neck flask to cause radical polymerization. After dropwise addition was completed, the reaction was continued at 75° C. for 3 hours.

Next, the temperature was raised to 80° C., the reaction was continued for 3 hours, and a copolymer solution having a resin concentration of 30% was obtained.

The obtained copolymer solution was transferred to a Teflon (registered trademark) bat and dried under a reduced pressure at 150° C. and 0.01 MPa for 3 hours, and DMF was distilled off to obtain a copolymer. This copolymer was coarsely pulverized with a hammer and then additionally pulverized with a mortar to obtain a powdered coating polymer compound (A).

### [Production of Coated Cathode Active Material Particles]

1 part of the coating polymer compound (A) was dissolved in 3 parts of DMF to obtain a coating polymer compound solution.

When 84 parts of cathode active material particles (LiNi0.8Co_{0.15}Al_{0.05}O₂; powder, volume average particle diameter 4 μm, manufactured by BASF Toda Materials Co., Ltd.) were put into a Universal Mixer High Speed Mixer FS25 [commercially available from EARTHTECHNICA Co., Ltd.] and stirred at room temperature and 720 rpm, 9 parts of the coating polymer compound solution was added dropwise over 2 minutes and additionally stirred for 5 minutes.

Next, in a stirred state, 3 parts of acetylene black (Denka Black (registered trademark) manufactured by Denka Co., Ltd.) as a conductive assistant and 4 parts of glass ceramic particles (product name: “Lithium ion conductive glass ceramics LICGC TMPW-01 (1 μm)” [manufactured by OHARA Co., Ltd.]) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

### Example 1

### [First Mixing Step]

99.25 parts of the coated cathode active material particles and 0.25 parts of Ketjenblack (KB) as the first conductive filler [manufactured by Lion Specialty Chemicals Co., Ltd., trade name “EC300J”, aspect ratio 1] were mixed for 5 minutes at 2000 rpm using a planetary stirring type mixing and kneading device {Awatori Rentaro [manufactured by Shinky Co., Ltd.]} to produce a powder for cathode.

### [Second Mixing Step]

99.5 parts of the powder for cathode, 46 parts of the electrolytic solution, and 0.5 parts of carbon nanofiber (CNF) as the second conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce a cathode composition.

### Examples 2 to 4

A cathode composition was produced in the same manner as in Example 1, except that the type and amount of the first conductive filler were changed as shown in Table 1.

In addition, in the first mixing step of Example 3, 0.5 part of Ketjenblack (KB) [manufactured by Lion Specialty Chemicals Co., Ltd., trade name “EC300J”, aspect ratio 1] as the first conductive filler and 1.0 part of flaky graphite (UP) [manufactured by Nippon Graphite Industries Co., Ltd., trade name “UP-5-α”, aspect ratio 2.2] were added.

### Comparison 1

In Comparison 1, the first conductive filler and the second conductive filler were mixed at the same time. In other words, the first mixing step and the second mixing step were not performed separately (in Table 1 described later, the first mixing step and the second mixing step are described as an absence).

99.25 parts of the coated cathode active material particles and 0.25 parts of Ketjenblack (KB) as the first conductive filler [manufactured by Lion Specialty Chemicals Co., Ltd., trade name “EC300J”, aspect ratio 1] and 0.5 parts of carbon nanofiber (CNF) as the second conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce a powder for cathode.

### Comparisons 2 to 4

A cathode composition was produced in the same manner as Comparison 1, except that the type and amount of the first conductive filler were changed as shown in Table 1.

Herein, in Comparison 3, 0.5 parts of Ketjenblack (KB) as the first conductive filler [manufactured by Lion Specialty Chemicals Co., Ltd., trade name “EC300J”, aspect ratio 1] and 1.0 part of flaky graphite (UP) [manufactured by Nippon Graphite Industries Co., Ltd., trade name “UP-5-α”: aspect ratio 2.2] were added.

### [Production of Coated Anode Active Material Particles A]

1 part of the coating polymer compound was dissolved in 3 parts of DMF to obtain a coating polymer compound solution.

When 80 parts of the anode active material particles (hard carbon powder, a volume average particle size of 25 μm, manufactured by JFE Chemical Co., Ltd.) were put into a Universal Mixer High Speed Mixer FS25 [commercially available from EARTHTECHNICA Co., Ltd.] and stirred at room temperature and 720 rpm, 38 parts of the coating polymer compound solution was added dropwise over 2 minutes and additionally stirred for 5 minutes.

Next, under stirring, 9.5 parts of acetylene black [Denka Black (registered trademark), commercially available from Denka Co., Ltd.] as a conductive assistant were added over 2 minutes in a divided manner, and stirring was continued for 30 minutes.

Then, the pressure was reduced to 0.01 MPa while stirring was maintained, the temperature was then raised to 140° C. while stirring and the degree of pressure reduction were maintained, and volatile components were distilled off while stirring, the degree of pressure reduction and the temperature were maintained for 8 hours.

The obtained powder was classified with a sieve with an opening of 200 μm to obtain coated anode active material particles.

### Example 5

### [First Mixing Step]

99.25 parts of the coated anode active material particles and 0.25 part of flaky graphite (UP) as the first conductive filler [manufactured by Nippon Graphite Industries Co., Ltd., trade name “UP-5-α”: aspect ratio 2.2] were mixed for 5 minutes at 2000 rpm using a planetary stirring type mixing and kneading device {Awatori Rentaro [manufactured by Shinky Co., Ltd.]} to produce a powder for anode.

### [Second Mixing Step]

99.5 parts of the powder for anode, 0.5 parts of carbon nanofiber (CNF) as the second conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce an anode composition.

### Comparison 5

In Comparison 5, the first conductive filler and the second conductive filler were mixed at the same time. In other words, the first mixing step and the second mixing step were not performed separately (in Table 1 described later, the first mixing step and the second mixing step are described as an absence).

99.25 parts of the coated anode active material particles, 46 parts of the electrolytic solution, 0.25 part of flaky graphite (UP) as the first conductive filler [manufactured by Nippon Graphite Industries Co., Ltd., trade name “UP-5-α”: aspect ratio 2.2 and 0.5 parts of carbon nanofiber (CNF) as the second conductive filler [Dona Carbo Milled S-243 manufactured by Osaka Gas Chemical Co., Ltd.: aspect ratio 30] were mixed for 5 minutes at 2000 rpm using a planetary stirring type mixing and kneading device {Awatori Rentaro [manufactured by Shinky Co., Ltd.]} to produce a powder for anode.

The first conductive filler and the second conductive filler listed in Table 1 are as follows.

### (First Conductive Filler)

Ketjenblack (KB) as the first conductive filler [manufactured by Lion Specialty Chemicals Co., Ltd., trade name “EC300J”, aspect ratio 1.5]
Acetylene black (AB) [manufactured by Denka Co., Ltd., trade name “Denka Black”, aspect ratio 1.0]
Flaky graphite (UP) [manufactured by Nippon Graphite Industries Co., Ltd., trade name “UP-5-α”, aspect ratio 2.2]

### (Second Conductive Filler)

carbon nanofiber (CNF) [Dona Carbo Milled S-243 manufactured by Osaka Gas Chemical Co., Ltd.: aspect ratio 30]

Each aspect ratio was measured using the method described in this specification.

### <Checking the Presence or Absence of Aggregates>

Regarding the cathode compositions and anode compositions prepared in Examples and Comparisons, the state of the surface of the electrode active material particle was measured using a scanning electron microscope (SEM, manufactured by Hitachi High-Technology, product name S-4800, magnification: 400 times) so as to determine whether or not aggregates were formed. The results are shown in Table 1.

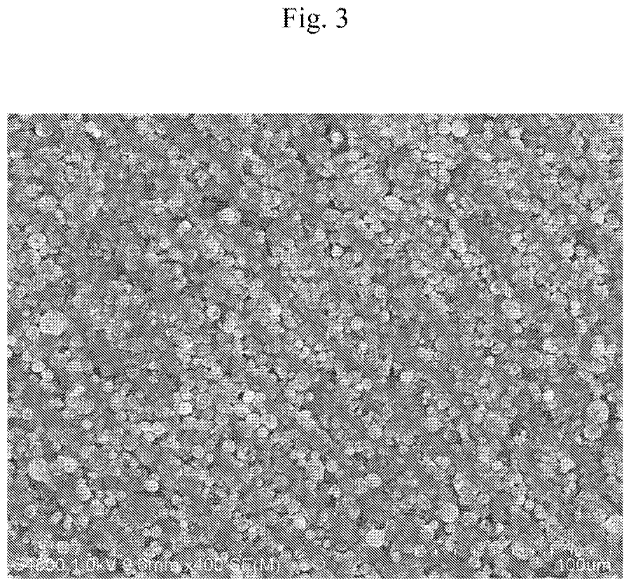

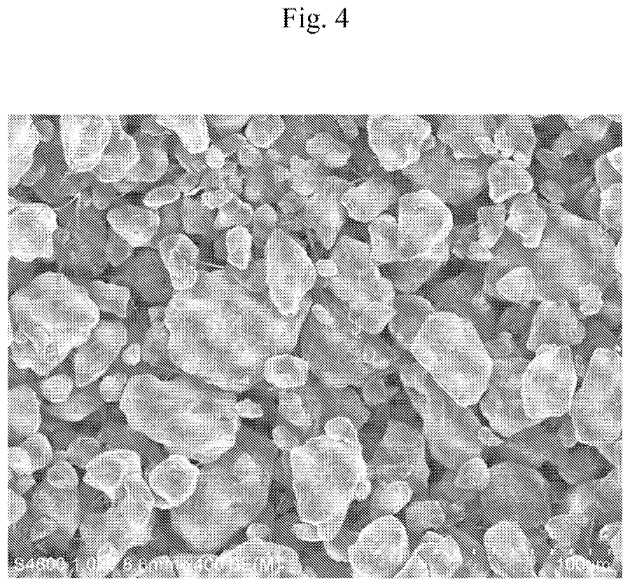

FIG. 3 is a scanning electron microscope (SEM) photograph of the cathode composition prepared in Example 1, and FIG. 4 is a scanning electron microscope (SEM) photograph of the anode composition prepared in Example 5.

As shown in FIGS. 3 and 4, no aggregates were observed in the scanning electron microscope (SEM) photographs of the cathode composition prepared in Example 1 and the anode composition prepared in Example 5.

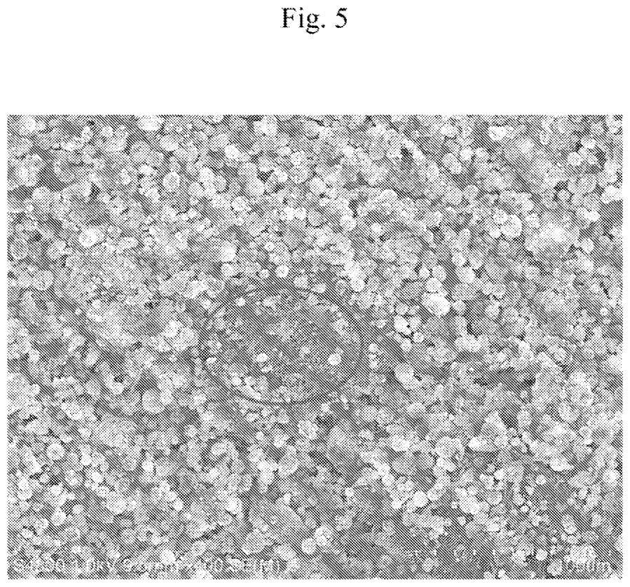

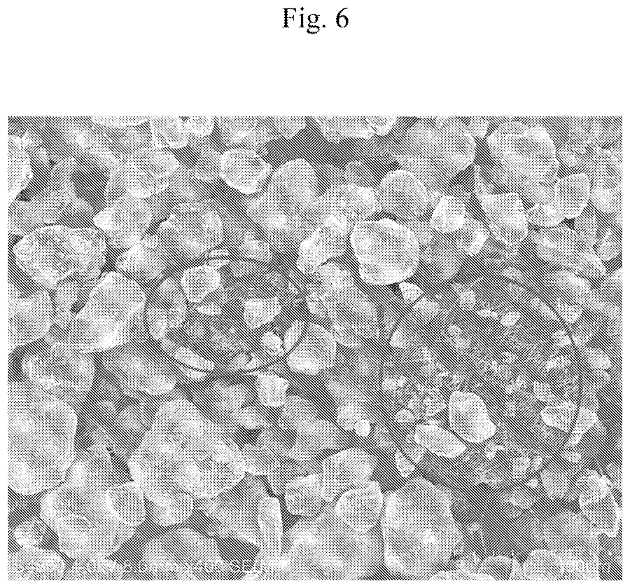

FIG. 5 is a scanning electron microscope (SEM) photograph of the cathode composition prepared in Comparison 1, and FIG. 6 is a scanning electron microscope (SEM) photograph of the anode composition prepared in Comparison 4.

As shown in FIG. 5, in terms of the cathode composition prepared in Comparison 1, in the circled area of the scanning electron microscope (SEM) photograph, aggregates of the first conductive filler and the second conductive filler were observed.

As shown in FIG. 6, in terms of the cathode composition prepared in Comparison 4, in the circled area of the scanning electron microscope (SEM) photograph, aggregates of the first conductive filler and the second conductive filler were observed.

### <Fluidity Evaluation>

For the cathode compositions and anode compositions prepared in Examples and Comparative Examples, the flow time was measured using a bulk specific gravity meter (manufactured by Tsutsui Rikagaku Kikai Co., Ltd., product name: Standard type bulk specific gravity meter, JIS K 6720).

Specifically, the time taken for 100 cm³ of the cathode composition or anode composition to flow down from the funnel was measured and evaluated based on the following criteria. The results are shown in Table 1.
◯: Flow time was 20 seconds or less.
X: Flow time exceeded 20 seconds.

TABLE 1

| | | | | Second | | | |
|---|---|---|---|---|---|---|---|
| | | First Conductive | | Conductive | | | |
| | | Filler | | Filler | Presence or | | |
| | | | Addition | Addition | absence of first | Presence or | |
| | Electrode | | amount | amount | mixing step and | absence of | Fluidity |
| | Composition | Type | (wt %) | (wt %) | second mixing step | aggregates | evaluation |
| Example 1 | Cathode | KB | 0.25 | 0.5 | Presence | Absence | ◯ |
| Example 2 | Cathode | UP | 0.25 | 0.5 | Presence | Absence | ◯ |
| Example 3 | Cathode | KB/UP | KB 0.5/UP 1.0 | 0.5 | Presence | Absence | ◯ |
| Example 4 | Cathode | AB | 0.25 | 0.5 | Presence | Absence | ◯ |
| Example 5 | Anode | UP | 0.25 | 0.5 | Presence | Absence | ◯ |
| Comparison 1 | Cathode | KB | 0.25 | 0.5 | Absence | Presence | X |
| Comparison 2 | Cathode | UP | 0.25 | 0.5 | Absence | Presence | X |
| Comparison 3 | Cathode | KB/UP | KB 0.5/UP 1.0 | 0.5 | Absence | Presence | X |
| Comparison 4 | Cathode | AB | 0.25 | 0.5 | Absence | Presence | X |
| Comparison 5 | Anode | UP | 0.25 | 0.5 | Absence | Presence | X |

### [Production of Resin Current Collector]

A resin current collector was prepared by the following method.

65 parts of polypropylene [product name “SunAllomer PL500A”, commercially available from SunAllomer Ltd.], 30 parts of carbon black [trade name: “#3030”, manufactured by Mitsubishi Chemical Corporation] and 5 parts of a dispersing agent [product name “UMEX 1001”, commercially available from Sanyo Chemical Industries, Ltd.] were melt-kneaded using a twin-screw extruder under conditions of 200° C. and 200 rpm to obtain a resin mixture.

The obtained resin mixture was passed through a T-die extrusion film forming machine and stretched and rolled to obtain a conductive film for a resin current collector having a film thickness of 100 μm.

Next, the obtained conductive film for a resin current collector was cut into 17.0 cm×17.0 cm, one side was subjected to nickel vapor deposition and a resin current collector to which a current extraction terminal (5 mm×3 cm) was connected was then obtained.

### [Production of Frame Member]

A polyolefin resin [Mersene (registered trademark) G manufactured by Tosoh Corporation] was formed into a 150 μm thick film by extrusion molding. And the film was punched out into an annular shape with an inner diameter of 11 mm×11 mm and an outer diameter of 15 mm×15 mm. And then the frame member was obtained.

### Example 6

### [Preparation of Cathode for Lithium-Ion Batteries]

30 parts of the electrolytic solution, 5 parts of acetylene black [Denka Black (registered trademark) manufactured by Denka Corporation] and 95 parts of the cathode composition prepared in Example 1 were mixed for 5 minutes at 2000 rpm using a planetary stirring type mixing and kneading device {Awatori Rentaro [manufactured by Shinky Co., Ltd.]} to produce a composition for a cathode active material layer.

The frame member was placed on the resin current collector, and the composition for a cathode active material layer was filled inside the frame member to have the same thickness as the frame member. Then pressing was carried out at a pressure of 1.4 MPa for about 10 seconds to produce a cathode for lithium-ion batteries according to Example 6.

### [Preparation of Anode for Lithium-Ion Batteries]

30 parts of the electrolytic solution, 5 parts of acetylene black [Denka Black trademark) (registered manufactured Denka Corporation] and 95 parts of the anode composition prepared in Example 5 were mixed for 5 minutes at 2000 rpm using a planetary stirring type mixing and kneading device {Awatori Rentaro [manufactured by Shinky Co., Ltd.]} to produce a composition for an anode active material layer.

The frame member was placed on the resin current collector, and the composition for an anode active material layer was filled inside the frame member to have the same thickness as the frame member. Then pressing was carried out at a pressure of 1.4 MPa for about 10 seconds to produce an anode for lithium-ion batteries according to Example 6.

### [Production of Lithium-Ion Battery]

The obtained anode for lithium-ion batteries and the cathode for lithium-ion batteries were combined via a separator (#3501, commercially available from Celgard LLC) to produce laminate cells. Then the lithium-ion battery according to Example 6 was produced by using the laminate cells.

### Examples 7 to 10, Comparison 6

A lithium-ion battery was produced in the same manner as in Example 6, except that the cathode composition used for cathode for lithium-ion batteries or the anode composition used for the anode for lithium-ion batteries was changed as shown in Table 2.

If both the evaluation of the electrical resistance value and the capacity retention rate were ◯ or Δ according to the following evaluation criteria, it was judged that deterioration of battery performance could be sufficiently suppressed.

### <Evaluation of Electrical Resistance Value>

The lithium-ion batteries produced in Examples and Comparisons were charged to 4.2 V at a current of 0.1 C at room temperature using a charge/discharge measuring device “Battery Analyzer Model 1470” [manufactured by Toyo Technica Co., Ltd.]. After resting for 10 minutes, the batteries were discharged to 2.5V with a current of 0.1 C.

The electrical resistance value of the lithium-ion battery was calculated from the voltage drop for 10 seconds from the start of discharge in the first cycle, and the evaluation was made based on the following criteria. The results are shown in Table 2.
◯: The electrical resistance value of the lithium-ion battery was less than 12 Ω·cm².
Δ: The electrical resistance value of the lithium-ion battery was 12 Ω·cm² or more and 18 Ω·cm² or less.
x: The electrical resistance value of the lithium-ion battery exceeded 18 Ω·cm².

### <Evaluation of Capacity Retention Rate>

The lithium-ion batteries produced in Examples and Comparisons were charged to 4.2V at a current of 0.1 C at 25° C. using a charge/discharge measuring device “Battery Analyzer Model 1470” [manufactured by Toyo Technica Co., Ltd.]. After resting for 10 minutes, the batteries were discharged to 2.5V with a current of 0.1 C, and this charging/discharging was repeated 20 cycles.

In this case, the battery capacity at the first charge (initial discharge capacity) and the battery capacity at the 20th cycle charge (discharge capacity after 20 cycles) were measured.

The capacity retention rate was calculated based on the following formula and evaluated based on the following criteria. The results are shown in Table 2. It is noted that the larger the value is, the less deterioration of the battery occurs.

Capacity retention rate (%)=(discharge capacity at 20th cycle/discharge capacity at 1st cycle)×100
◯: The capacity retention rate of the lithium-ion battery exceeded 95.0%.
Δ: The capacity retention rate of the lithium-ion battery was 70.0% or more and 95.0% or less.
x: The capacity retention rate of the lithium-ion battery was less than 70.0%.

TABLE 2

| | Cathode for | Anode for | | | | |
|---|---|---|---|---|---|---|
| | lithuim-ion | lithium-ion | Electrical | | Capacity | |
| | batteries | batteries | resistance value | | retention rate | |
| | Type of cathode | Type of anode | Number | | Number | |
| | composition | composition | (Ω * cm²) | Evaluation | (%) | Evaluation |
| Example 6 | Example 1 | Example 5 | 11.1 | ◯ | 95.1 | ◯ |
| Example 7 | Example 1 | Comparison 5 | 14.3 | Δ | 90.5 | Δ |
| Example 8 | Example 3 | Example 5 | 11.8 | ◯ | 95.8 | ◯ |
| Example 9 | Example 3 | Comparison 5 | 15.0 | Δ | 88.2 | Δ |
| Example 10 | Comparison 1 | Example 5 | 17.2 | Δ | 70.8 | Δ |
| Comparison 6 | Comparison 1 | Comparison 5 | 18.6 | X | 61.7 | X |

The electrode compositions produced in Examples did not form aggregates and were excellent in fluidity evaluation. Furthermore, it was observed that the lithium-ion batteries using the electrode composition produced in the Examples could suppress deterioration of battery performance.

### INDUSTRIAL APPLICABILITY

The method of manufacturing an electrode composition for lithium-ion batteries is available as a method of manufacturing an electrode composition for lithium-ion batteries used for mobile phones, personal computers, hybrid vehicles, electric vehicles, and so on.

1. A method of manufacturing an electrode composition for lithium-ion batteries, the method including:
a first mixing step of obtaining a powder for electrodes by mixing coated electrode active material particles for lithium-ion batteries, in which at least a part of the surface of the electrode active material particles is coated with a polymer compound, with a first conductive filler having an aspect ratio of 10 or less; and
a second mixing step of obtaining an electrode composition by mixing the powder for electrodes with a second conductive filler having an aspect ratio of 15 or more.

2. The method of manufacturing an electrode composition for lithium-ion batteries according to claim 1,
wherein the polymer compound is a polymer containing methacrylic acid, methyl methacrylate, and 2-ethylhexyl methacrylate as essential constituent monomers.

3. The method of manufacturing an electrode composition for lithium-ion batteries according to claim 1,
wherein the weight proportion of the first conductive filler is 0.2 to 5 wt % based on the weight of the electrode composition.

4. The method of manufacturing an electrode composition for lithium-ion batteries according to claim 1,
wherein the weight proportion of the second conductive filler is 0.1 to 5 wt % based on the weight of the electrode composition.
